(19) United States
(12) Patent Application Publication
(10) Pub. No.: US 2011/0278092 A1
(43) Pub. Date: Nov. 17, 2011

(54) GIRT PANEL ASSEMBLY

(76) Inventor: FRANK JOHN BROWN, Bayville, NJ (US)

(21) Appl. No.: 13/108,242

(22) Filed: May 16, 2011

Related U.S. Application Data
(60) Provisional application No. 61/334,680, filed on May 14, 2010.

(51) Int. Cl. A62B 1/20; B60R 99/00

(52) U.S. Cl. 182/48; 160/89

(57) ABSTRACT

Described are girt panel assemblies including a panel, at least two hinges coupled to the panel, and at least one fabric girt coupled to the panel. The fabric girt may also be configured to couple to an evacuation slide. The evacuation slide may, but not necessarily, include a sill tube, where an upper fabric girt is coupled to an upper surface of the sill tube and a lower fabric girt is coupled to a lower surface of the sill tube. In these examples, the sill tube applies pressure to the upper fabric girt and the lower fabric girt when inflated. As a result, the sill tube is positioned between a lower surface of the panel and the passenger vehicle when inflated.

### CROSS REFERENCE TO RELATED APPLICATION

This application is related to and claims priority benefits from U.S. Provisional Application Ser. No. 61/334,680, filed on May 14, 2010, entitled RIGID GIRT PANEL FOR EVACUATION SLIDES. The '680 application is hereby incorporated herein in its entirety by this reference.

### FIELD OF THE INVENTION

The invention relates to evacuation slides for use with passenger vehicles or the like.

### BACKGROUND

Over the past fifty years, evacuation slides have been designed for passenger vehicles. Typically, an evacuation slide is required on passenger vehicles where the doorway height is such that passengers would be unable to exit from the door uninjured. These evacuation slides may utilize a fabric girt to attach the evacuation slide to the passenger vehicle. A girt is a term for the portion of the evacuation slide system that connects the slide to the passenger vehicle. The necessity of having to engage (connect) and disengage (disconnect) the evacuation slide to and from the passenger vehicle door each time the door is closed and re-opened has dictated the use of a girt bar and fabric girt on traditional passenger vehicles to facilitate this process.

While the girt bar and fabric girt may provide a quick connect/disconnect design for the evacuation slides, this design may not provide sufficient stability for the evacuation slide in some cases. For example, certain regulations require that the evacuation slide must withstand 25 knot winds during deployment. In some circumstances, the fabric girt and girt bar may not prevent the evacuation slide from twisting and moving laterally under these wind loads.

In addition, some passenger vehicles include upper deck doors, which are not routinely used during normal operation of the passenger vehicle. As a result, the evacuation slides in these locations can stay connected (engaged) to the passenger vehicle door since the exit is used on a limited basis. Thus, the need for quick connect/disconnect design is not as prevalent in these locations.

In order to provide a more stable coupling between the evacuation slide and the passenger vehicle that is better able to withstand the required wind loads, it may be desirable to have a more rigid design for the attachment between the evacuation slide and the passenger vehicle for certain applications, such as the upper deck passenger vehicle doors.

### SUMMARY

Embodiments of the invention may comprise a girt panel assembly having a panel, at least two hinges coupled to the panel, and at least one fabric girt coupled to the panel. The panel may be formed of a rigid material, and the hinges may be pivotally coupled to at least two girt brackets via at least two quick release pins.

In some embodiments, the fabric girt comprises a raised rim coupled to an end of the panel, wherein a retainer strip may be coupled to the raised rim. The fabric girt may be configured to couple to an evacuation slide. In some embodiments, the evacuation slide includes a sill tube, and the fabric girt comprises an upper fabric girt coupled to an upper surface of the sill tube and a lower fabric girt coupled to a lower surface of the sill tube. In these embodiments, the sill tube applies pressure to the upper fabric girt and the lower fabric girt when inflated. As a result, the sill tube is positioned between a lower surface of the panel and the passenger vehicle when inflated. In these embodiments, the girt panel assembly is configured to deploy the evacuation slide in wind conditions of up to at least 25 knots.

In some embodiments, the panel is configured to extend through a passenger vehicle doorway when the girt panel assembly is in a deployed position. In this position, the girt panel assembly comprises a platform positioned between the passenger vehicle and the evacuation slide.

### BRIEF DESCRIPTION OF THE DRAWINGS

FIG. 1 is a front perspective view of a girt panel assembly according to one embodiment of the present invention in use with an evacuation slide.

FIG. 2 is a top perspective view of the girt panel assembly of FIG. 1.

FIG. 3 is a bottom view of a girt panel assembly according to an alternative embodiment of the present invention.

FIG. 4 is a partial perspective view of the girt panel assembly of FIG. 1 without an endplate attached.

FIG. 5 is a partial perspective view of the girt panel assembly of FIG. 1 with an endplate attached.

FIG. 6 is a partial perspective view of the girt panel assembly of FIG. 1.

FIG. 7 is a side view of the girt panel assembly of FIG. 1 in use with an evacuation slide.

FIG. 8 is a rear perspective view of the girt panel assembly of FIG. 1 in use with an evacuation slide.

FIG. 9 is a perspective view of a girt panel assembly according to another alternative embodiment of the present invention without a fabric girt attached.

FIG. 10 is a partial perspective view of the girt panel assembly of FIG. 9 without a fabric girt attached.

FIG. 11 is a perspective view of the girt panel assembly of FIG. 9 with a fabric girt attached.

FIG. 12 is another perspective view of the girt panel assembly of FIG. 9 with a fabric girt attached.

### DETAILED DESCRIPTION

The described embodiments of the invention provide a girt panel assembly for use with an evacuation slide. While the girt panel assemblies are discussed for use with aircraft, they are by no means so limited. Rather, embodiments of the girt panel assemblies may be used in conjunction with evacuation slides for vehicles of any type or otherwise as desired.

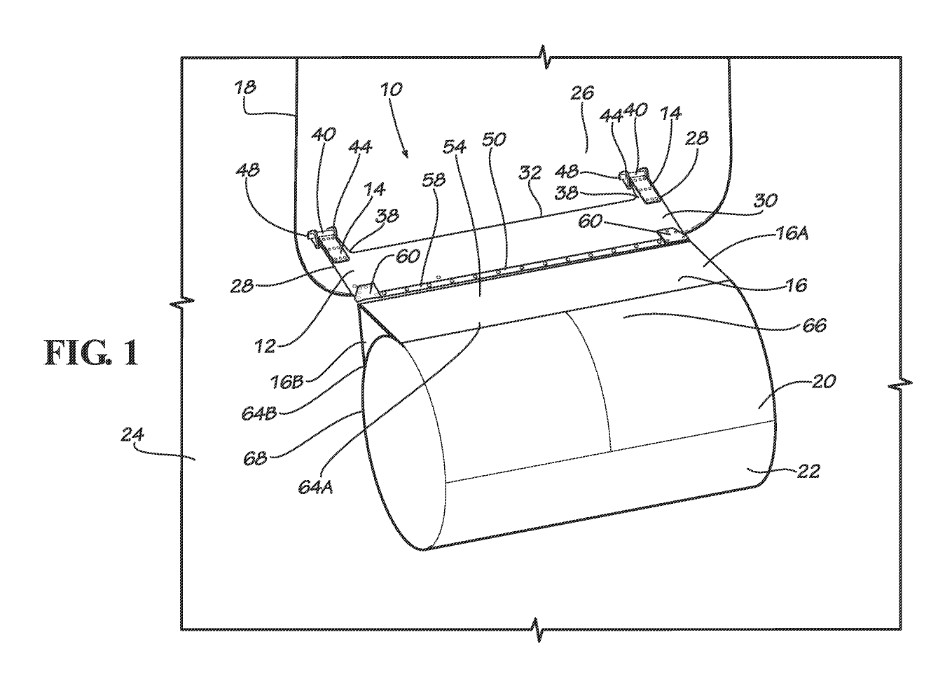

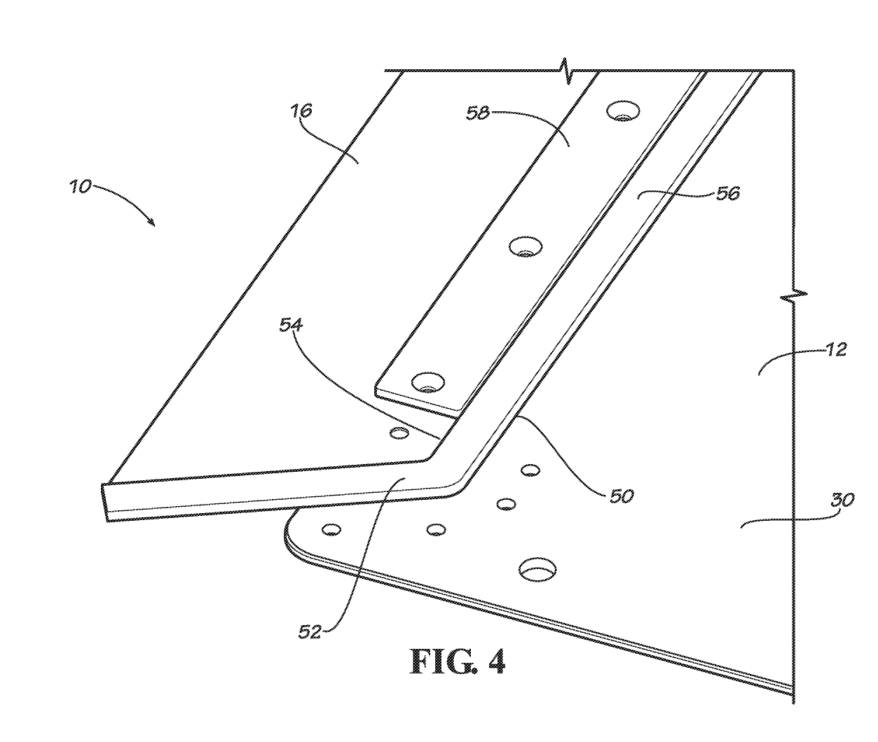

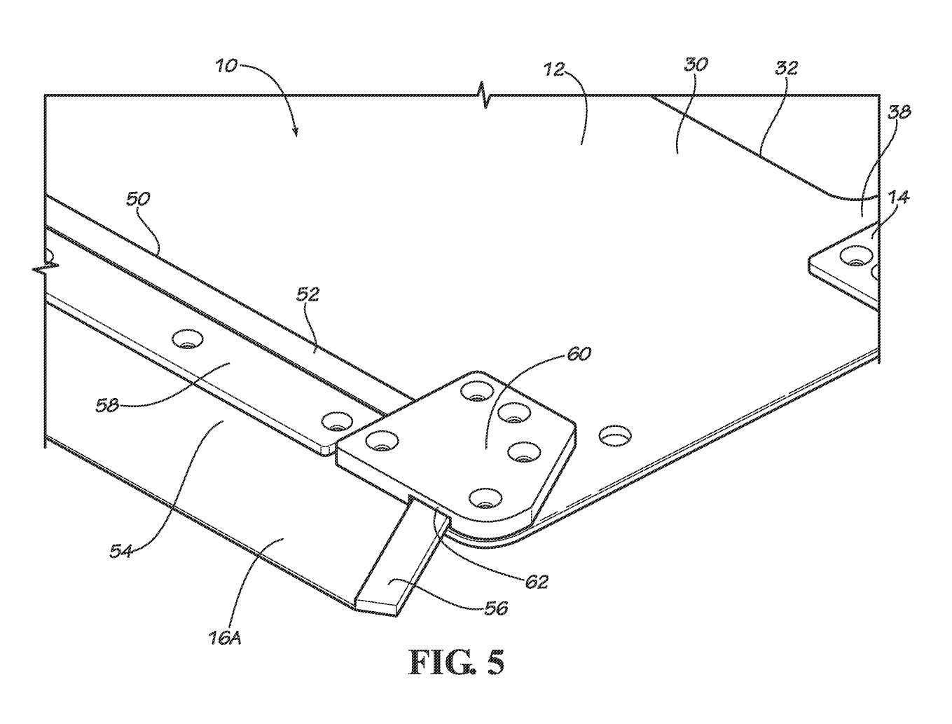

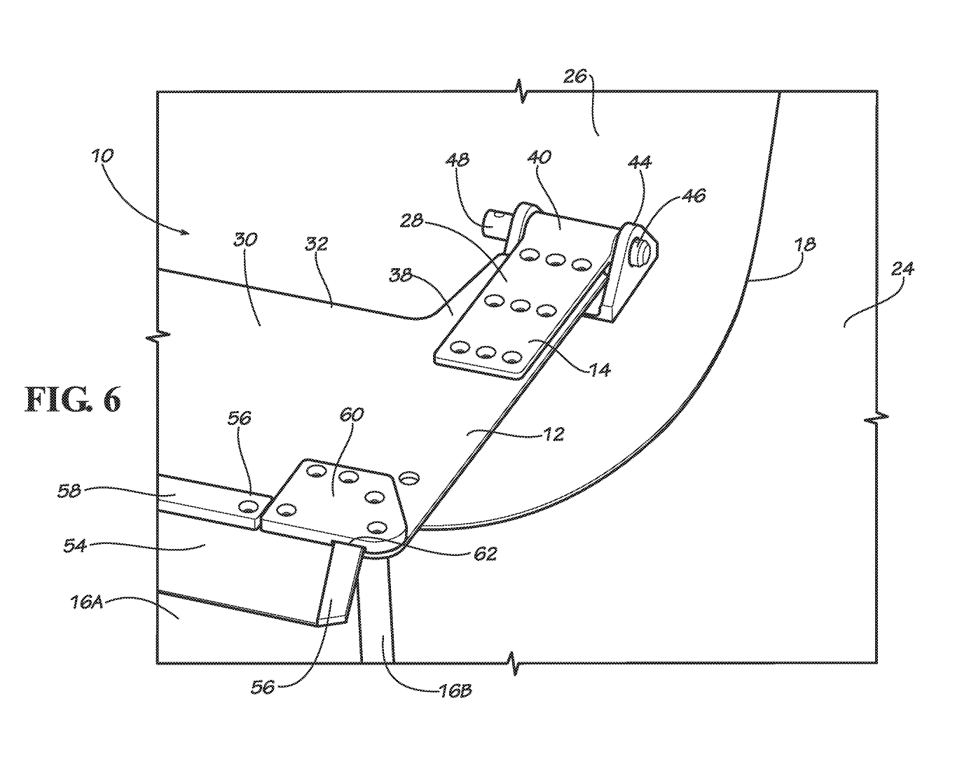

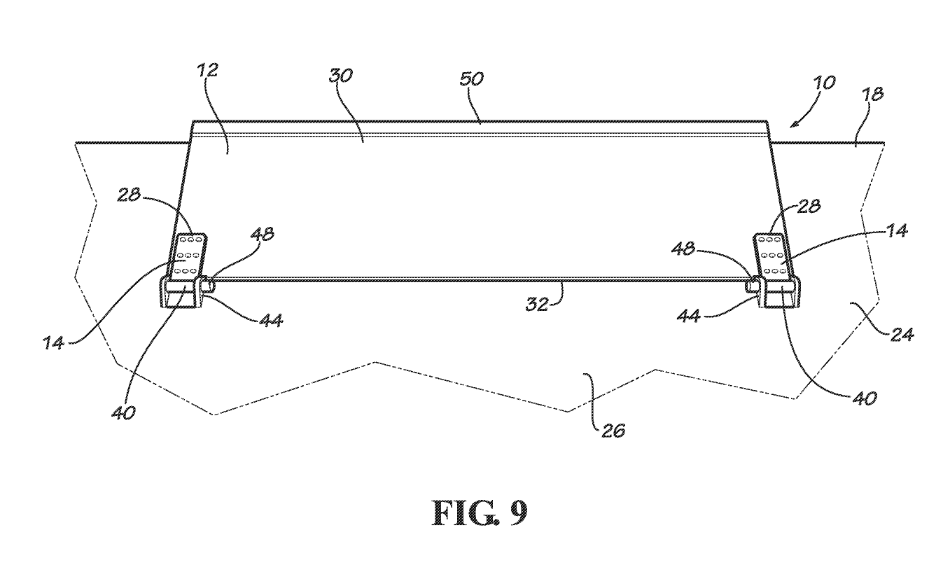

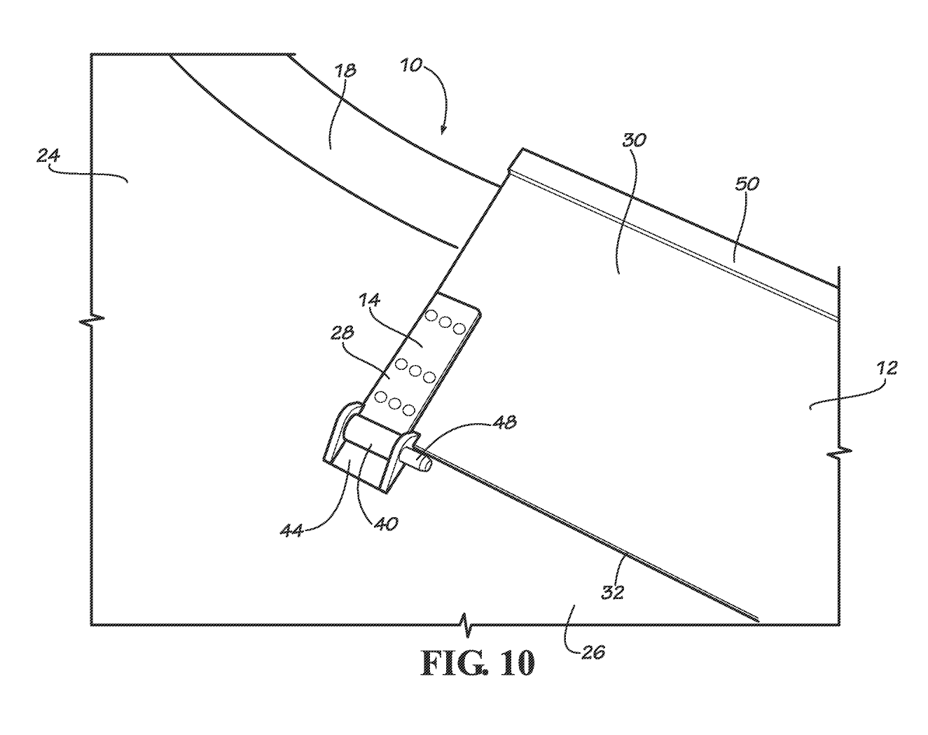

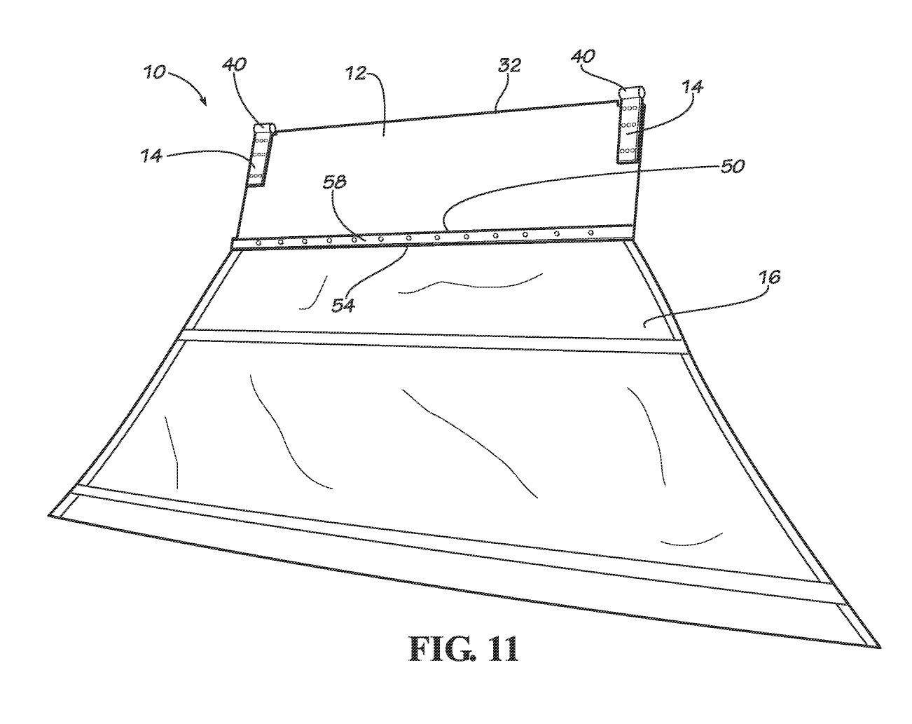

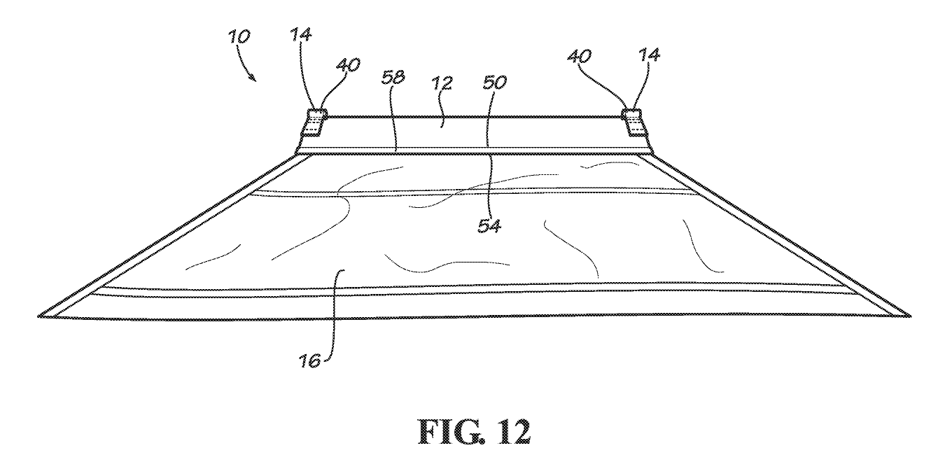

FIGS. 1-12 illustrate embodiments of a girt panel assembly 10. In these embodiments, the girt panel assembly 10 comprises a panel 12, at least two hinges 14, and at least one fabric girt 16. The panel 12 may be formed of any suitably rigid material that provides sufficient torsional stiffness and lateral stability for the girt panel assembly 10. Examples of suitable materials include but are not limited to stainless steel, aluminum, other metallic materials, composite materials, or other suitable materials. In some embodiments, the panel 12 has a substantially rectilinear shape. Other suitable shapes include but are not limited to trapezoidal, I-shape, or other polygonal shapes. The dimensions of the panel 12 are substantially determined by the sizes of a passenger vehicle doorway 18 and a slide container (not shown), which is used to stow an evacuation slide 20.

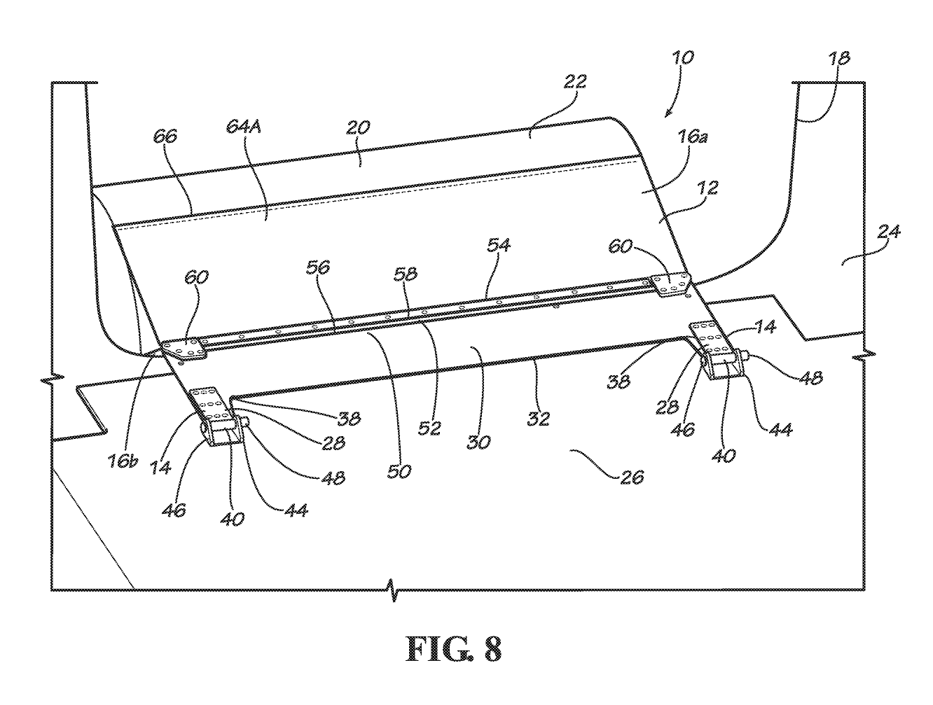

In some embodiments, as shown in FIGS. 1 and 8, a width of the panel 12 is configured to be as wide as possible, while also allowing the panel 12 to fit through the passenger vehicle doorway 18 and stow underneath the slide container. Maximizing the width of the panel 12 provides more bearing surface between the evacuation slide 20 and a passenger vehicle 24. The larger width also maximizes the amount of contact between the evacuation slide 20 and the passenger vehicle 24, which decreases the amount of twist and lateral movement of the evacuation slide when deploying the evacuation slide in high winds.

In some embodiments, as shown in FIGS. 1 and 6-10, a length of the panel 12 is configured to be as long as possible, while also allowing the panel 12 to couple to a floor 26 of the passenger vehicle 24 and the evacuation slide 20. Maximizing the length allows the panel 12 to extend as far outboard as possible when the girt panel assembly 10 is deployed, which decreases the freedom of movement available for the evacuation slide 20 relative to the passenger vehicle 24.

In the embodiments shown in FIGS. 1-3 and 6-12, a first coupling component 28 of each hinge 14 may be coupled to a first surface 30 of the panel 12 adjacent a mounting edge 32 of the panel 12. The mounting edge 32 may be positioned substantially parallel to the passenger vehicle doorway 18.

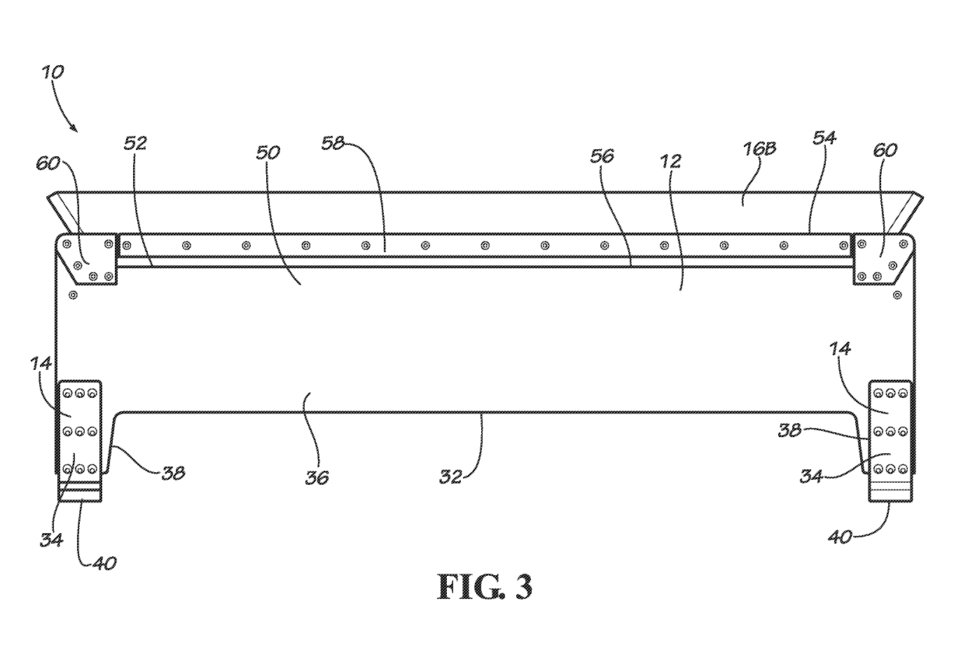

In some embodiments, such as in the alternative embodiment shown in FIG. 3, the hinge 14 may include a second coupling component 34 that is hingedly coupled to the first coupling component 28 and coupled to a second surface 36 of the panel 12. In this embodiment, a portion of the panel 12 is sandwiched between the two coupling components 28, 34 of the hinge 14.

The first coupling component 28 and/or the second coupling component 34 may be coupled to the panel 12 via any suitable mechanical or chemical fastening mechanisms, including but not limited to, screws, bolts, rivets, welding, gluing, or integrally forming with the panel 12.

In some embodiments, as shown in FIGS. 1-3, 6, and 8, the panel 12 also includes at least two projections 38 that are positioned along the mounting edge 32. Each projection 38 may be shaped to substantially conform to the shape of the first coupling component 28 (and the optional second coupling component 34) of each hinge 14. The use of the projections 38 allows the length of the panel 12 to be further maximized without adding unnecessary weight to the panel 12 in the space between the projections 38.

Each hinge 14 may also comprise a pivot joint 40. The pivot joint 40 is positioned adjacent the first coupling component 28. In the embodiments where the hinge 14 also includes the second coupling component 34, the pivot joint 40 is positioned between the first coupling component 28 and the second coupling component 34 and forms the joint about which the coupling components 28, 34 pivot relative to each other. In some embodiments, the pivot joint 40 includes a central aperture 42.

In the embodiments shown in FIGS. 1 and 6-10, the at least two hinges 14 are configured to couple to at least two girt brackets 44, which are mounted to the floor 26 of the passenger vehicle 24. Each girt bracket 44 may be formed of stainless steel, aluminum, other metallic materials, composite materials, or other suitable materials.

The girt bracket 44 includes apertures 46 that are shaped to approximate the diameter of the central aperture 42 of the pivot joint 40. The pivot joint 40 is configured to fit within the girt bracket 44 so that the apertures 46 are substantially aligned with the central aperture 42. In some embodiments, the at least two hinges 14 are secured to the at least two girt brackets 44 by at least two quick release pins 48. Each quick release pin 48 is inserted through the apertures 46 on the girt bracket 44 and the central aperture 42 of the pivot joint 40.

The panel 12 may be coupled to the evacuation slide 20 via the fabric girt 16. In some embodiments, such as the embodiments illustrated in FIGS. 1-3 and 6-8, the fabric girt 16 comprises an upper fabric girt 16A and a lower fabric girt 16B. One of ordinary skill in the relevant art will understand that any suitable number of fabric girts 16 may be used to secure the panel 12 to the evacuation slide 20.

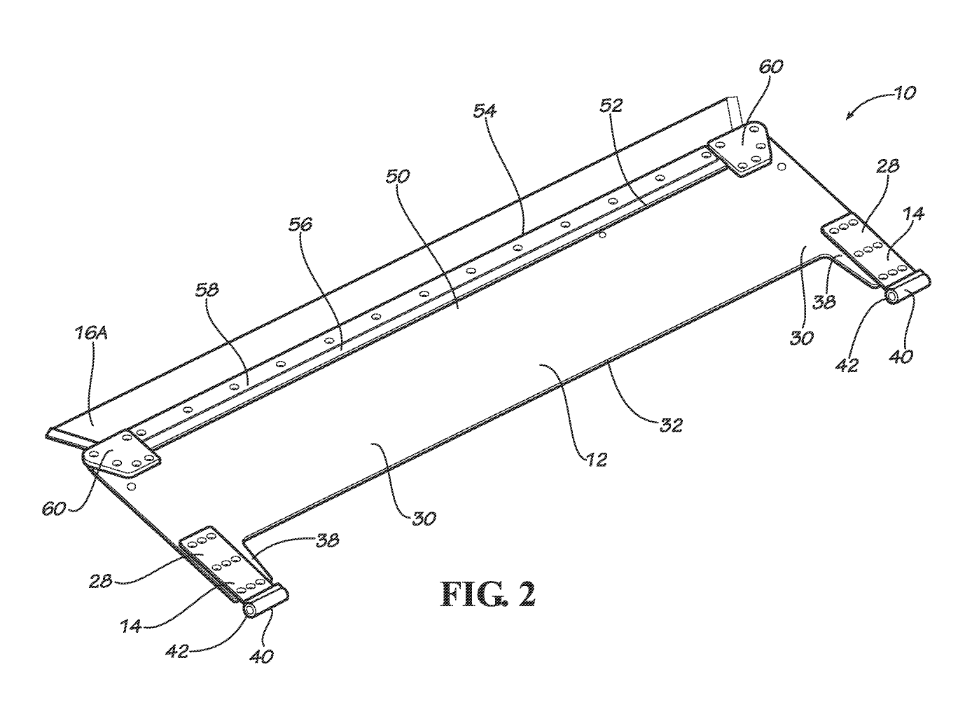

In these embodiments, the upper fabric girt 16A and the lower fabric girt 16B are coupled to an outboard edge 50 of the panel 12. As best shown in FIGS. 2-6, each of the fabric girts 16A, 16B includes a webbing bead 52 that may be sewn into a first end 54 of each of the fabric girts 16A, 16B. The webbing bead 52 may comprise a raised rim 56. A retainer strip 58 is configured to fit within the shape formed by the raised rim 56 in each fabric girt 16A, 16B. At least two endplates 60 may be used to secure each of the fabric girts 16A, 16B to the panel 12. Each endplate 60 includes a track 62 that is configured to substantially conform to a portion of the raised rim 56. Once each endplate 60 is positioned over the portion of the raised rim 56, the endplate 60 is then secured to the retainer strip 58 via mechanical fasteners, including but not limited to, screws, bolts, rivets, or other suitable fastening devices. As a result, the webbing bead 52 is then sandwiched between the retainer strip 58 and the endplate 60. The retainer strip 58 and/or webbing bead 52 of each fabric girt 16A, 16B may be further secured to the panel 12 via additional mechanical fasteners inserted through the retainer strip 58 and/or the webbing bead 52 and the outboard edge 50 of the panel 12.

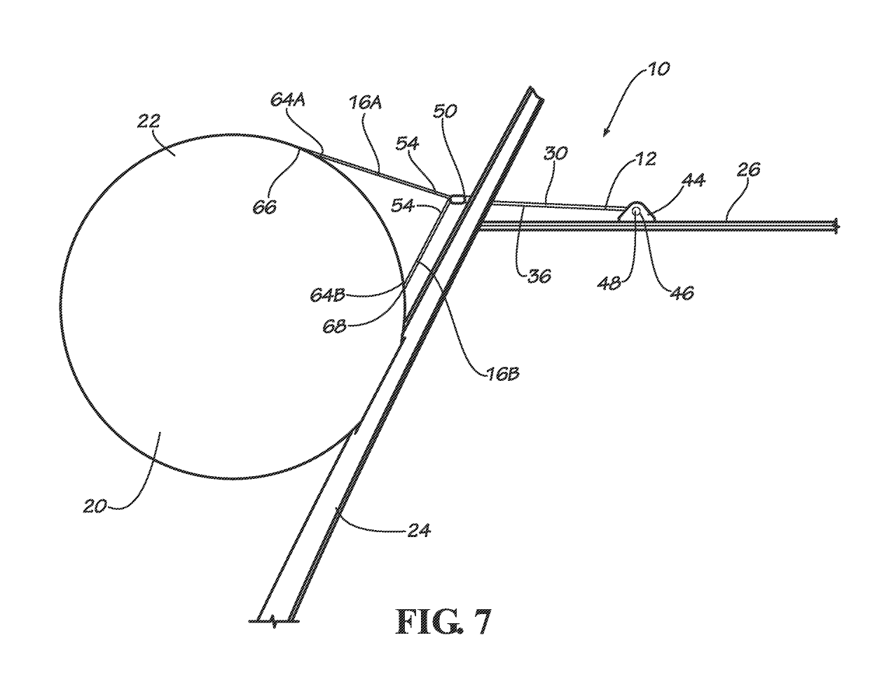

In the embodiments best illustrated in FIGS. 1 and 7, a second end 64A of the upper fabric girt 16A is coupled to an upper surface 66 of a sill tube 22 of the evacuation slide 20, and a second end 64B of the lower fabric girt 16B is coupled to a lower surface 68 of the sill tube 22. The fabric girts 16A, 16B are coupled to the sill tube 22 via any suitable chemical fasteners including but not limited to adhesives, plastic welding, or other suitable attachment mechanisms to ensure that the sill tube 22 remains coupled to the fabric girts 16A, 16B once deployed. The sill tube 22 forms an upper part of the evacuation slide 20.

When the evacuation slide 20 is stowed, fabric girts 16A, 16B provide flexibility for the evacuation slide 20 to be stowed within the slide container, while the fabric girts 16A, 16B extend out of the slide container to couple to the girt panel assembly 10, which is stowed underneath the slide container (not shown).

When the evacuation slide 20 is deployed, the slide container is dragged outboard and rotates out of the passenger vehicle doorway 18 as a passenger vehicle door is opened. Because the fabric girts 16A, 16B are coupled to both the girt panel assembly 10 and the sill tube 22 of the evacuation slide 20, the girt panel assembly 10 is pulled along by the evacuation slide 20, which in turn causes the girt panel assembly 10 to rotate about the pivot joints 40 relative to the girt brackets 44.

As the slide container falls out of the passenger vehicle doorway 18, the girt panel assembly 10 continues to rotate until the panel 12 is extended outboard from the passenger vehicle 24 across the passenger vehicle doorway 18. In this deployed position, as best shown in FIG. 7, the girt panel assembly 10 serves as a walkway and platform for passengers to reach the evacuation slide 20, as well as a mechanism to secure the evacuation slide 20 to the passenger vehicle 24.

As the slide container drops below the passenger vehicle doorway 18, inflation of the evacuation slide 20 is initiated. The evacuation slide 20 deploys and inflates to its intended position between the ground and the passenger vehicle 24 for evacuation. When the evacuation slide 20 is inflated, the sill tube 22 also is inflated so that the pressure inside the sill tube 22 applies a tension force to the fabric gifts 16A, 16B. As a result, the upper fabric girt 16A pulls the evacuation slide 20 in an inboard direction, which keeps the evacuation slide 20 in snug contact with the passenger vehicle 24. At the same time, the lower fabric girt 16B pulls the evacuation slide 20 into snug contact with the second surface 36 of the panel 12 and the passenger vehicle 24. By wedging the sill tube 22 between the panel 12 and the passenger vehicle 24, the twisting and lateral loads from the evacuation slide 20 are transferred to the girt panel assembly 10. As a result, the girt panel assembly 10 demonstrated, during testing, successful evacuation slide 20 deployment in wind conditions of up to at least 25 knots.

The foregoing is provided for purposes of illustrating, explaining, and describing embodiments of the present invention. Further modifications and adaptations to these embodiments will be apparent to those skilled in the art and may be made without departing from the scope or spirit of the invention.

That which is claimed is:

1. A girt panel assembly comprising:
(a) a panel;
(b) at least two hinges coupled to the panel; and
(c) at least one fabric girt coupled to the panel.

2. The girt panel assembly of claim 1, wherein the panel is formed of a rigid material.

3. The girt panel assembly of claim 1, wherein the at least one fabric girt comprises a raised rim coupled to an end of the panel.

4. The girt panel assembly of claim 3, further comprising a retainer strip coupled to the raised rim.

5. The girt panel assembly of claim 1, wherein the at least one fabric girt is configured to couple to an evacuation slide.

6. The girt panel assembly of claim 5, wherein the at least one fabric girt comprises an upper fabric girt and a lower fabric girt.

7. The girt panel assembly of claim 1, wherein the at least two hinges are configured to pivotally couple to at least two girt brackets.

8. The girt panel assembly of claim 7, further comprising at least two quick release pins that are configured to couple the at least two hinges to the at least two girt brackets.

9. The girt panel assembly of claim 1, wherein the panel is configured to extend through a passenger vehicle doorway when the girt panel assembly is in a deployed position.

10. A passenger vehicle comprising:
(a) a girt panel assembly comprising:
(i) a panel;
(ii) at least two hinges coupled to the panel; and
(iii) at least one fabric girt coupled to the panel; and
(b) an evacuation slide coupled to the at least one fabric girt.

11. The passenger vehicle of claim 10, wherein the panel is formed of a rigid material.

12. The passenger vehicle of claim 10, wherein the evacuation slide further comprises a sill tube, and wherein the at least one fabric girt comprises an upper fabric girt coupled to an upper surface of the sill tube and a lower fabric girt coupled to a lower surface of the sill tube.

13. The passenger vehicle of claim 12, wherein the sill tube applies pressure to the upper fabric girt and the lower fabric girt when inflated.

14. The passenger vehicle of claim 13, wherein the sill tube is positioned between a lower surface of the panel and the passenger vehicle when inflated.

15. The passenger vehicle of claim 10, wherein the girt panel assembly in a deployed position comprises a platform positioned between the passenger vehicle and the evacuation slide.

16. The passenger vehicle of claim 10, wherein the girt panel assembly is configured to deploy the evacuation slide in wind conditions of up to at least 25 knots.

17. A method of operating a girt panel assembly, the girt panel assembly comprising a panel pivotally coupled to a floor of a passenger vehicle, the steps comprising:
(a) rotating the girt panel assembly relative to the floor until the panel extends through a passenger vehicle doorway; and
(b) inflating an evacuation slide coupled to the panel.

18. The method of claim 17, further comprising positioning a sill tube of the evacuation slide between a lower surface of the panel and the passenger vehicle.

19. The method of claim 18, wherein the girt panel assembly comprises a platform positioned between the passenger vehicle and the evacuation slide when the panel is extended through the passenger vehicle doorway.

20. The method of claim 17, wherein the panel is formed of a rigid material.
